(19) United States
(12) Patent Application Publication
(10) Pub. No.: US 2025/0218646 A1
(43) Pub. Date: Jul. 3, 2025

(54) TRANSFORMER AND X-RAY SYSTEM

(71) Applicant: Shanghai United Imaging Healthcare Co., Ltd., Shanghai (CN)

(72) Inventors: Biao Luo, Shanghai (CN); Guoping Zhu, Shanghai (CN); Jinglin Wu, Shanghai (CN)

(21) Appl. No.: 19/004,564

(22) Filed: Dec. 30, 2024

(30) Foreign Application Priority Data
Dec. 29, 2023 (CN) 202311870551.9

(51) Int. Cl. H01F 27/28; H01F 27/24; H05G 2/00

(52) U.S. Cl. CPC H01F 27/28; H01F 27/24; H05G 2/00

(57) ABSTRACT

The present disclosure provides a transformer and an X-ray system. The transformer includes M primary windings and M*N distributed magnetic cores. The M primary windings are supplied with a M-phase alternating current, a first end of each of the M primary windings is supplied with an alternating current of a corresponding phase in the M-phase alternating current, and second ends of the M primary windings are connected to each other after passing through a plurality of distributed magnetic cores in the M*N distributed magnetic cores. The secondary winding on each distributed magnetic core is connected to a corresponding one of a plurality of rectifier units connected in series to output a secondary voltage.

### CROSS-REFERENCE TO RELATED APPLICATIONS

This application claims priority to Chinese patent application No. 202311870551.9, filed on Dec. 29, 2023, the entire content of which is incorporated herein by reference.

### TECHNICAL FIELD

The present disclosure relates to the technical field of transformers, and in particular, to a transformer and an X-ray system.

### BACKGROUND

An inverter circuit at a front end of a conventional high-voltage generator is generally configured as an H-bridge single-phase inverter circuit. The single-phase inverter circuit can invert a direct-current (DC) voltage into a high-frequency alternating-current (AC) square wave, and then output the high-frequency AC square wave to a single-phase high-voltage transformer through resonant elements such as an inductor and a capacitor. A primary winding of a conventional centralized high-voltage transformer includes one winding or a plurality of windings in parallel, and a secondary winding generally includes a plurality of windings. Each secondary winding is connected to a corresponding rectifier and filter circuit, and all rectifier and filter circuits are connected in series to form a high-voltage unit.

In order to achieve a purpose of fast switching of a high peak voltage (kilovolts peak), a switching frequency of a device may be increased or an output capacitance of the device may be reduced, so as to speed up a response of the circuit. However, increasing the switching frequency will increase losses in the inverter circuit, the high-voltage transformer, and the rectifier circuit, and will also increase a dielectric loss of the high-voltage unit. Moreover, reducing the output capacitance will lead to an increase in ripple in an output voltage.

### SUMMARY

An objective of the present disclosure is to provide a transformer and an X-ray system, aiming to solve the problem of increased ripple in the output voltage caused by reducing the output capacitance of the conventional high-voltage generator.

To address the above technical problems, a first aspect of the present disclosure provides a transformer. The transformer includes M primary windings and M*N distributed magnetic cores. The M primary windings are supplied with a M-phase alternating current. A first end of each of the M primary windings is supplied with an alternating current of a corresponding phase in the M-phase alternating current, and second ends of the M primary windings are connected to each other after passing through a plurality of distributed magnetic cores in the M*N distributed magnetic cores. M is an integer greater than or equal to 3, and N is an integer greater than or equal to 2. each of the M*N distributed magnetic cores is provided with a corresponding secondary winding, and each secondary winding is connected to a corresponding one of a plurality of rectifier units connected in series.

In some embodiments, the M*N distributed magnetic cores are divided into N magnetic core groups, and each magnetic core group includes M distributed magnetic cores.

In some embodiments, ends of the secondary windings on the M distributed magnetic cores in each magnetic core group are connected to each other according to a delta connection method or a star connection method.

In some embodiments, dotted terminals of the secondary windings on the M distributed magnetic cores in each magnetic core group are connected to each other.

In some embodiments, the secondary windings on the M distributed magnetic cores in each magnetic core group have a same number of turns.

In some embodiments, the M primary windings are connected to each other after passing through N distributed magnetic cores sequentially.

In some embodiments, projections of the N distributed magnetic cores through which each primary winding passes coincide with each other on a horizontal plane.

In some embodiments, the M primary windings are connected to each other after passing through 2N distributed magnetic cores sequentially.

In some embodiments, each distributed magnetic core is passed through by two primary windings.

In some embodiments, a number of the rectifier units is the same as a number of the magnetic core groups, and the N magnetic core groups are connected to N rectifier units in a one-to-one correspondence.

In some embodiments, an output end of each rectifier unit is connected in parallel with at least one filtering unit.

In some embodiments, a compensation unit is connected between secondary windings on the M distributed magnetic cores in each magnetic core group.

In some embodiments, each compensation unit includes M compensation capacitors connected in parallel.

In some embodiments, the transformer further includes: N printed circuit boards configured to fix the N magnetic core groups, respectively. Each printed circuit board are provided with M through holes, and the M through holes are configured to receive the M distributed magnetic cores in each magnetic core group.

In some embodiments, the M distributed magnetic cores in each magnetic core group are arranged in a one-to-one correspondence with the M through holes, and the M distributed magnetic cores are arranged in a triangle shape in a case that M is equal to 3.

In some embodiments, an end of each secondary winding on the M distributed magnetic cores in each magnetic core group is connected to a corresponding rectifier bridge arm in the rectifier unit, and another end of each secondary winding on the M distributed magnetic cores in each magnetic core group is connected to an adjacent secondary winding.

In some embodiments, each rectifier bridge arm includes at least two diodes, and the at least two diodes are connected in series.

In some embodiments, first ends of all the rectifier bridge arms in each rectifier unit are connected to a common connection point, and second ends of all the rectifier bridge arms in each rectifier unit are connected to each other through a voltage grading ring.

In some embodiments, the N printed circuit boards are arranged layer by layer, and directions of forward currents of the rectifier bridge arms between two adjacent printed circuit boards are opposite.

A second aspect of the present disclosure further provides an X-ray system, including the transformer as described in any one of the above embodiments.

One or more embodiments of the present disclosure will be described in detail below with reference to drawings. Other features, objects and advantages of the present disclosure will become more apparent from the description, drawings, and claims.

### BRIEF DESCRIPTION OF THE DRAWINGS

In order to describe the technical solutions in the embodiments of the present disclosure more clearly, the following briefly introduces the accompanying drawings required for describing the embodiments or for describing the conventional art. Apparently, the accompanying drawings in the following description shows merely some embodiments of the present disclosure, and do not constitute a limitation to scope of the present disclosure, for a person of ordinary skill in the art, other drawings can also be obtained according to these accompanying drawings without making any creative efforts.

FIG. 1 is a schematic diagram showing a circuit structure of a distributed multiphase transformer according to an embodiment of the present disclosure.

FIG. 2 is a schematic diagram showing a circuit structure of a distributed three-phase transformer according to an embodiment of the present disclosure.

FIG. 3 is a schematic diagram showing a three-phase inverter circuit according to an embodiment of the present disclosure.

FIG. 4 is a schematic perspective diagram showing a distributed multiphase transformer according to an embodiment of the present disclosure.

FIG. 5 is a schematic diagram showing a partial structure of a distributed multiphase transformer according to an embodiment of the present disclosure.

FIG. 6 is a schematic perspective diagram showing a distributed multiphase transformer according to another embodiment of the present disclosure.

FIG. 7 is a schematic diagram showing a circuit structure of a distributed multiphase transformer according to another embodiment of the present disclosure.

FIG. 8 is a schematic perspective diagram of the distributed multiphase transformer in FIG. 7.

FIG. 9 is a schematic diagram showing a partial structure of a distributed multiphase transformer according to another embodiment of the present disclosure.

FIG. 10 is a schematic diagram showing a circuit structure of a distributed multiphase transformer according to yet another embodiment of the present disclosure.

FIG. 11 is a schematic diagram showing a circuit structure of a distributed three-phase transformer according to another embodiment of the present disclosure.

FIG. 12 is a schematic diagram showing a partial structure of a distributed three-phase transformer according to an embodiment of the present disclosure.

### DETAILED DESCRIPTION OF THE EMBODIMENTS

In order to make the technical problems to be solved, technical solutions and beneficial effects of the present disclosure more clearly understood, the present disclosure will be further described in detail with the accompanying drawings and embodiments. It should be understood that the specific embodiments described herein are only used to explain the present disclosure and not to limit the present disclosure.

It should be noted that when an element is referred to as being “fixed on” or “disposed on” another element, it may be directly on the other element or indirectly on the other element. When an element is referred to as being “connected to” another element, it may be directly connected to the other element or indirectly connected to the other element.

It should be understood that the orientation or positional relationship indicated by terms such as “length”, “width”, “upper”, “lower”, “front”, “back”, “left”, “right”, “vertical”, “horizontal”, “top”, “bottom”, “inner” and “outer” are the orientation or positional relationship as shown in the accompanying drawings, and are merely intended to facilitate the description of the present disclosure and simplify the description, rather than indicating or implying that the indicated device or element must have a specific orientation or be constructed and operated in a specific orientation. Therefore, these terms are not to be interpreted as limiting the present disclosure.

In addition, the terms such as “first” and “second” are used for descriptive purposes only, and should not be understood as indicating or implying relative importance or implicitly indicating the quantity of the technical features indicated. Thus, the features described with “first” and “second”, etc., may explicitly or implicitly include one or more of these features. In the description of the present disclosure, the term “plurality” means two or more, unless otherwise clearly and specifically defined.

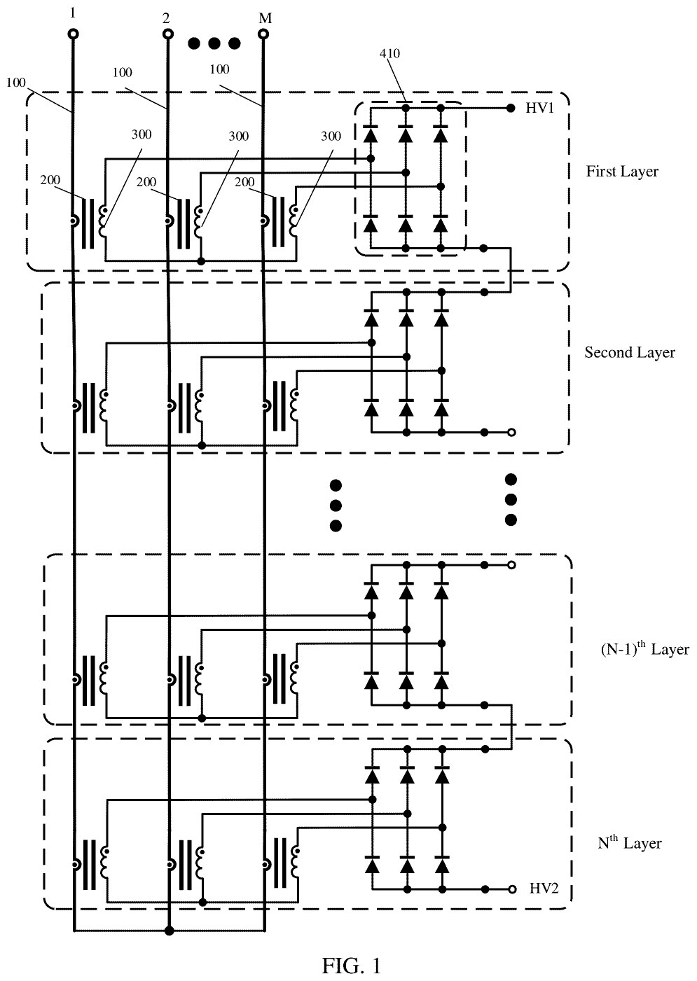

In order to address the above technical problems, an embodiment of the present disclosure provides a transformer, and in particular, a distributed multiphase transformer. As shown in FIG. 1, the distributed multiphase transformer in this embodiment includes M primary windings 100 and M*N distributed magnetic cores. The M primary windings 100 are supplied with a M-phase alternating current. Specifically, a first end of each of the M primary windings 100 is supplied with an alternating current of a corresponding phase in the M-phase alternating current. Second ends of the M primary windings 100 are connected to each other after passing through a plurality of distributed magnetic cores 200. Each distributed magnetic core 200 is provided with a corresponding secondary winding 300, and each secondary winding 300 is connected to a corresponding rectifier unit 410. A plurality of rectifier units 410 are connected in series.

In this embodiment, M is an integer greater than or equal to 3, and N is an integer greater than or equal to 2. The first ends of the M primary windings 100 are respectively supplied with an alternating current of a corresponding phase in the M-phase alternating current, and the second ends of the M primary windings 100 are connected to each other after passing through the plurality of distributed magnetic cores 200, thereby forming a distributed multiphase transformer. The rectifier units 410 connected to the secondary windings 300 on each group of distributed magnetic cores 200 are connected in series as an output end of the distributed multiphase transformer. Compared with the related art, smaller ripple in the output voltage can be achieved at the same frequency and output capacitance.

In some embodiments, the number of distributed magnetic cores 200 passed through by each primary winding 100 is the same. For example, if M is equal to 3, the number of distributed magnetic cores 200 passed through by the primary winding 100 is N, and three primary windings 100 are connected to each other after passing through the corresponding N distributed magnetic cores 200 respectively. Each distributed magnetic core 200 is provided with the corresponding secondary winding 300.

In some embodiments, the primary winding 100 passing through the distributed magnetic core 200 means that the primary winding 100 may pass through a center of the distributed magnetic core 200, or the primary winding 100 may be wound around the distributed magnetic core 200.

In some embodiments, as shown in FIG. 1, each primary winding 100 passes through the corresponding N distributed magnetic cores 200 sequentially, and the plurality of primary windings 100 are connected to each other after passing through the same number of distributed magnetic cores 200.

In some embodiments, each primary winding 100 passes through the plurality of distributed magnetic cores 200, so the overall structure has a relatively integrated distributed high-voltage transformer structure, which can significantly reduce the insulation requirement of the secondary winding 300 on the distributed magnetic cores 200. Furthermore, even if a distributed magnetic core 200 on a certain high-voltage side fails, it will not cause abnormal operation of the entire distributed multiphase transformer, thereby enhancing the robustness of the distributed multiphase transformer.

In an embodiment, each primary winding 100 may be a single cable or a cable bundle consisting of a plurality of cables. The number of cables in the cable bundle may be set according to the requirement of the application scenario.

In some embodiments, as shown in FIG. 1, the secondary winding 300 on each distributed magnetic core 200 is connected to a corresponding rectifier unit 410. An output end of a circuit formed by connecting the plurality of rectifier units 410 in series may be taken as the output end of the distributed multiphase transformer. The output end includes a first voltage output end HV1 and a second voltage output end HV2. Polarities of the first voltage output end HV1 and the second voltage output end HV2 of the distributed multiphase transformer may be the same, or may be set to be different according to the requirement of the application scenario.

In some embodiments, the first voltage output terminal HV1 of the distributed multiphase transformer may be grounded, and the second voltage output terminal HV2 of the distributed multiphase transformer outputs a negative voltage.

In some embodiments, the first voltage output terminal HV1 of the distributed multiphase transformer may output a positive voltage, and the second voltage output terminal HV2 of the distributed multiphase transformer is grounded.

In some embodiments, the first voltage output terminal HV1 of the distributed multiphase transformer may output a positive voltage, and the second voltage output terminal HV2 of the distributed multiphase transformer may output a negative voltage. In this case, the output end of one of the plurality of rectifier units 410 may be configured to be connected to a reference ground.

In an embodiment, the M primary windings 100 have a same number of turns. A phase difference of voltages supplied to two adjacent primary windings 100 is 360°/M. Specifically, taking the three primary windings 100 as an example, the three primary windings 100 have a same number of turns, and phases of input voltages of the three primary windings 100 are offset by 120°.

In some embodiments, the M*N distributed magnetic cores 200 are divided into N magnetic core groups, and each magnetic core group includes M distributed magnetic cores 200.

In this embodiment, each magnetic core group has the same circuit and core structure, and the M distributed magnetic cores 200 in each magnetic core group correspond to M primary windings 100, respectively. Taking each primary winding 100 passing through N distributed magnetic cores 200 as an example, the M primary windings 100 pass through the M distributed magnetic cores 200 in each magnetic core group, respectively. As shown in FIG. 1, the first ends of the M primary windings 100 are supplied with alternating currents of respective phases in the M-phase alternating current, respectively. The M primary windings 100 pass through the M distributed magnetic cores 200 in the first to last magnetic core group until the second ends of the M primary windings 100 extend out of the M distributed magnetic cores 200 in the last magnetic core group. And then the second ends of the M primary windings 100 are connected to each other.

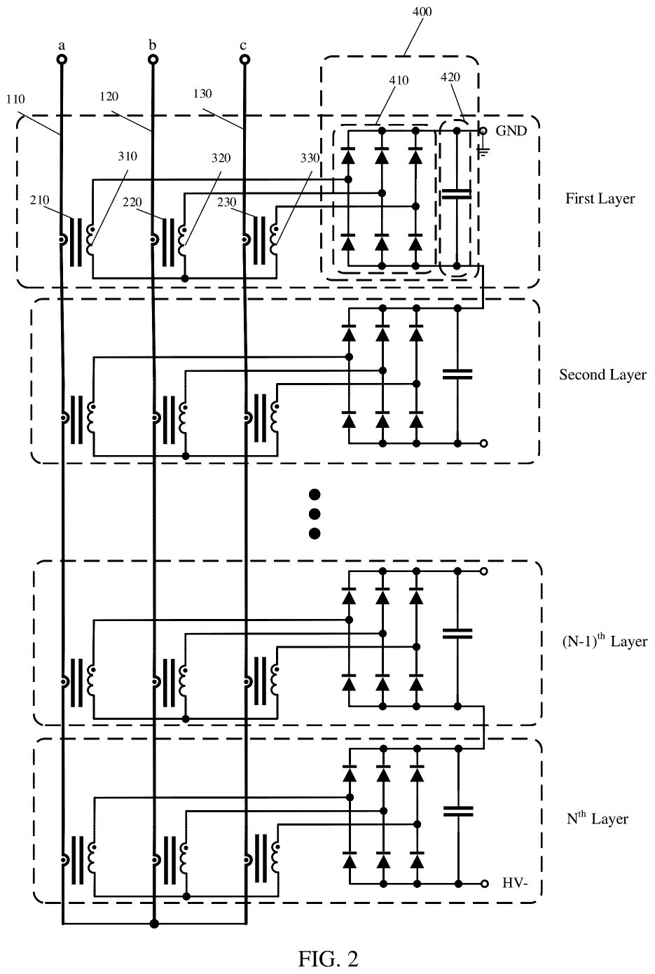

Referring to FIG. 2, taking M equal to 3 as an example for illustration, the M*N distributed magnetic cores 200 are divided into N magnetic core groups, and each magnetic core group includes three distributed magnetic cores 200.

In some embodiments, as shown in FIG. 2, the N magnetic core groups are arranged layer by layer, and each layer of magnetic core group includes a first distributed magnetic core 210, a second distributed magnetic core 220, and a third distributed magnetic core 230. A first primary winding 110 passes through the first distributed magnetic core 210, a second primary winding 120 passes through the second distributed magnetic core 220, and a third primary winding 130 passes through the third distributed magnetic core 230. The first distributed magnetic core 210 is wound with a first secondary winding 310, the second distributed magnetic core 220 is wound with a second secondary winding 320, and the third distributed magnetic core 230 is wound with a third secondary winding 330. The first secondary winding 310, the second secondary winding 320 and the third secondary winding 330 in the same magnetic core group are each connected to the same rectifier unit 410. N layers of magnetic core groups are connected to N rectifier units 410 in a one-to-one correspondence, and the N rectifier units 410 are connected in series.

In some embodiments, as shown in FIG. 2, the output end of each rectifier unit 410 is connected in parallel to at least one filtering unit 420.

In this embodiment, the rectifier unit 410 and the filter unit 420 are connected in parallel to form a rectifier and filter circuit 400. The secondary winding 300 on the distributed magnetic core 200 in each magnetic core group is connected to the corresponding rectifier and filter circuit 400. N rectifier and filter circuits 400 are connected in series sequentially. The head end of the first rectifier and filter circuit 400 may be taken as the first voltage output end HV1 of the distributed multiphase transformer and configured to be grounded, and the last end of the last rectifier and filter circuit 400 may be taken as the second voltage output end HV2 of the distributed multiphase transformer to output a negative voltage HV-.

In some embodiments, with reference to FIG. 1, the rectifier unit 410 may be formed by a plurality of rectifier bridge arms in parallel, and each rectifier bridge arm may be formed by an upper diode and a lower diode connected in series. An end of the secondary winding 300 is connected to a common node of the upper diode and the lower diode, and another end of the secondary winding 300 is connected to an adjacent secondary winding. The number of rectifier bridge arms in each rectifier unit 410 is the same as the number of distributed magnetic cores 200 in the corresponding magnetic core group. The secondary winding 300 on each distributed magnetic core 200 is connected to one of the rectifier bridge arms of the corresponding rectifier unit 410.

In some embodiments, the number of the rectifier units 410 is the same as the number of the magnetic core groups, and the plurality of magnetic core groups are connected to the plurality of rectifier units 410 in a one-to-one correspondence.

As described with reference to FIG. 2, in a case that M is equal to 3, the distributed multiphase transformer is a distributed three-phase transformer. Taking M equal to 3 as an example, the rectifier unit 410 includes three parallel rectifier bridge arms. An end of the first secondary winding 310 is connected to the first rectifier bridge arm of the corresponding rectifier unit 410, an end of the second secondary winding 320 is connected to the second rectifier bridge arm of the corresponding rectifier unit 410, and an end of the third secondary winding 330 is connected to the third rectifier bridge arm of the corresponding rectifier unit 410. The other end of the first secondary winding 310, the other end of the second secondary winding 320, and the other end of the third secondary winding 330 are connected to each other.

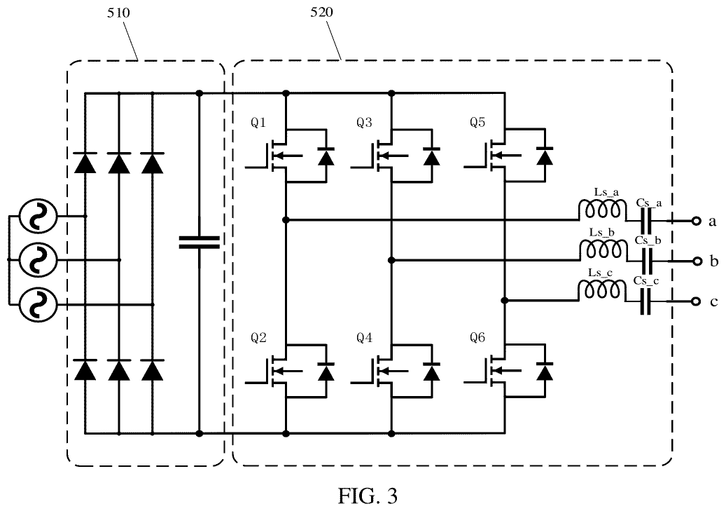

FIG. 3 is a schematic diagram showing a three-phase inverter circuit according to an embodiment of the present disclosure. With reference to FIG. 3, an alternating current (AC) supplied by an AC power supply is rectified and filtered by a rectifier and filter circuit 510 and then output to an inverter circuit 520. The rectified and filtered AC are converted from AC to DC by the inverter circuit 520 and then output to a first end a of the first primary winding 110, a first end b of the second primary winding 120, and a first end c of the third primary winding 130 in this embodiment. Further, the alternating current from the AC power supply after AC-DC conversion is finally transformed by the distributed multiphase transformer in this embodiment and then output. The inverter circuit 520 includes an inverter bridge and a filter circuit. A first switch tube Q1 and a second switch tube Q2 form a first inverter bridge, a third switch tube Q3 and a fourth switch tube Q4 form a second inverter bridge, and a fifth switch tube Q5 and a sixth switch tube Q6 form a third inverter bridge. A first inductor Ls_a and a first capacitor Cs_a in the filter circuit are connected in series and connected to the first inverter bridge, a second inductor Ls_b and a second capacitor Cs_b in the filter circuit are connected in series and connected to the second inverter bridge, and a third inductor Ls_c and a third capacitor Cs_c in the filter circuit are connected in series and connected to the third inverter bridge.

In some embodiments, the secondary windings 300 on the M distributed magnetic cores 200 in each magnetic core group have a same number of turns.

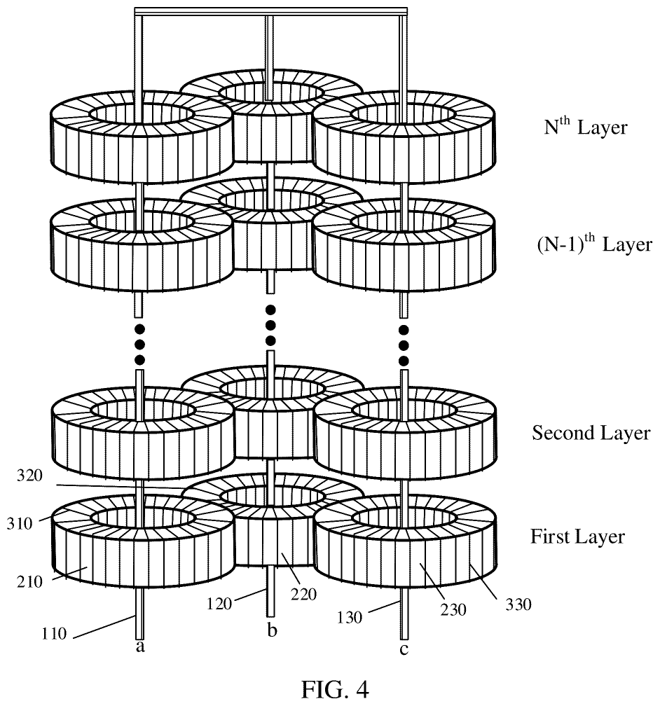

In some embodiments, as shown in FIG. 4, the secondary windings 300 on the M distributed magnetic cores 200 in each layer of magnetic core group have a same number of turns, and the M primary windings 100 pass through the centers of the M distributed magnetic cores 200 in each layer of magnetic core group respectively. Taking M equal to 3 as an example, the first end a of the first primary winding 110 is supplied with the A-phase alternating current, the first end b of the second primary winding 120 is supplied with the B-phase alternating current, and the first end c of the third primary winding 130 is supplied with the C-phase alternating current. The second ends of the first primary winding 110, the second primary winding 120, and the third primary winding 130 are connected to each other.

In some embodiments, as shown in FIG. 4, N layers of magnetic core groups are arranged layer by layer, and have the same structure. A projection of the first distributed magnetic core 210 in each layer of magnetic core group on a horizontal plane coincides with a projection of the first distributed magnetic core 210 in the adjacent magnetic core group on the horizontal plane, a projection of the second distributed magnetic core 220 in each layer of magnetic core group on the horizontal plane coincides with a projection of the second distributed magnetic core 220 in the adjacent magnetic core group on the horizontal plane, and a projection of the third distributed magnetic core 230 in each layer of magnetic core group on the horizontal plane coincides with a projection of the third distributed magnetic core 230 in the adjacent magnetic core group on the horizontal plane. In this way, the first end a of the first primary winding 110 may pass through the first distributed magnetic core 210 in each layer of magnetic core group layer by layer from the center of the first distributed magnetic core 210 in the first layer of magnetic core group, the first end b of the second primary winding 120 may pass through the second distributed magnetic core 220 in each layer of magnetic core group layer by layer from the center of the second distributed magnetic core 220 in the first layer of magnetic core group, and the first end c of the third primary winding 130 may pass through the third distributed magnetic core 230 in each layer of magnetic core group layer by layer from the center of the third distributed magnetic core 230 in the first layer of magnetic core group. The second ends of the first primary winding 110, the second primary winding 120, and the third primary winding 130 are connected to each other.

In some embodiments, dotted terminals of the secondary windings 300 on the M distributed magnetic cores 200 in each magnetic core group are connected to each other.

In some embodiments, ends of the secondary windings 300 on the M distributed magnetic cores 200 in each magnetic core group are connected to each other according to a delta connection method or a star connection method.

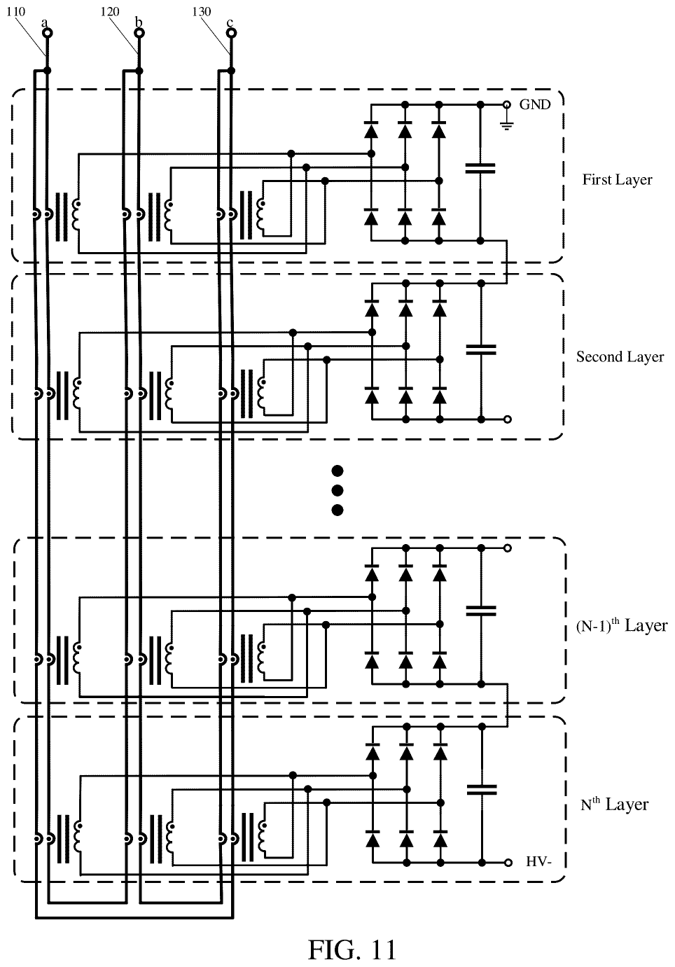

The star connection method means that first ends of the secondary windings 300 on the M distributed magnetic cores 200 are connected together to form a common point, as shown in FIGS. 1, 2, and 7. The delta connection method means that a first end of each secondary winding 300 is connected to a second end of another secondary winding 300, as shown in FIG. 11.

In this embodiment, the secondary windings 300 on the M distributed magnetic cores 200 in each magnetic core group are connected to each other. In the same magnetic core group, the ends of the secondary windings 300 on the M distributed magnetic cores 200 may be connected to the corresponding rectifier bridge arm, respectively, and the other ends of the secondary windings 300 on the M distributed magnetic cores 200 may be connected to each other according to the delta connection method or the star connection method.

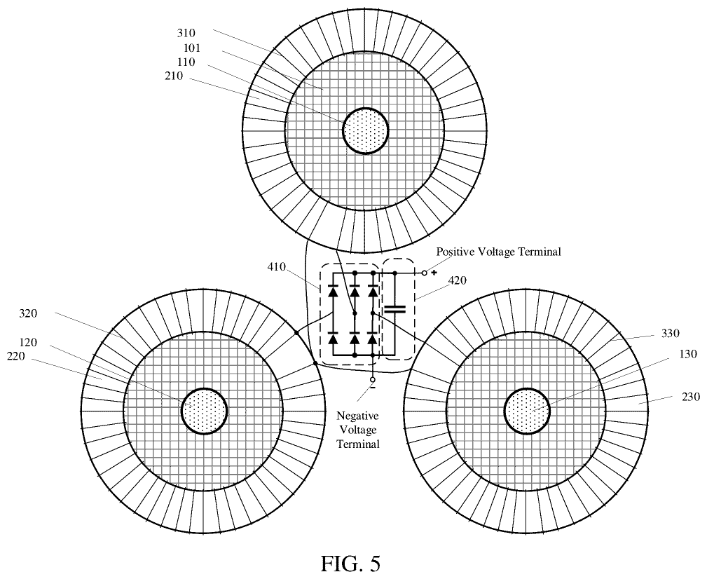

In an embodiment, FIG. 5 is a schematic diagram showing a structure of one layer in a distributed multiphase transformer. Taking M equal to 3 as an example, the three distributed magnetic cores are arranged in an equilateral triangle shape, the three secondary windings are tightly wound around the corresponding distributed magnetic core, respectively. Three primary windings are located at the center of the corresponding distributed magnetic core, respectively. An insulating medium 101 is filled between each primary winding and the corresponding secondary winding. The ends of the three secondary windings on the same layer of distributed magnetic cores are connected to the corresponding rectifier bridge arm in the rectifier unit 410, respectively, and the other ends of the three secondary windings on the same layer of distributed magnetic cores are connected to each other.

As shown in FIG. 5, the first distributed magnetic core 210, the second distributed magnetic core 220, and the third distributed magnetic core 230 are arranged in an equilateral triangle shape. The first primary winding 110 is located at the center of the first distributed magnetic core 210, the second primary winding 120 is located at the center of the second distributed magnetic core 220, and the third primary winding 130 is located at the center of the third distributed magnetic core 230. The first secondary winding 310 is wound around the first distributed magnetic core 210, and the insulating medium 101 is filled between the first primary winding 110 and the first secondary winding 310. The first ends of the first secondary winding 310, the second secondary winding 320, and the third secondary winding 330 are connected to each other, and the second ends of the first secondary winding 310, the second secondary winding 320, and the third secondary winding 330 are connected to the corresponding rectifier bridge arm in the rectifier unit 410, respectively.

In some embodiments, a direction of forward current of a diode in the rectifier unit 410 determines a positive voltage terminal and a negative voltage terminal. By adjusting the direction of the forward current of the diode, the positive and negative voltage terminals may be switched. With reference to FIG. 5, the two diodes connected in series in each rectifier bridge arm in the rectifier unit 410 have the same direction of forward current. A common connection point of cathodes of all rectifier bridge arms is taken as the positive voltage terminal, and a common connection point of anodes of all rectifier bridge arms is taken as the negative voltage terminal.

In some embodiments, to achieve series voltage boosting of two adjacent layers, the positions of the two high-voltage output terminals may be fixed, and then the series connection of the rectifier and filter circuits 400 of the two adjacent layers may be achieved by adjusting the directions of forward currents of the diodes of the two adjacent layers.

In some embodiments, the M primary windings 100 are connected to each other after passing through the distributed magnetic cores 200 in the N magnetic core groups, sequentially. In other words, each primary winding 100 passes through the N distributed magnetic cores 200 sequentially.

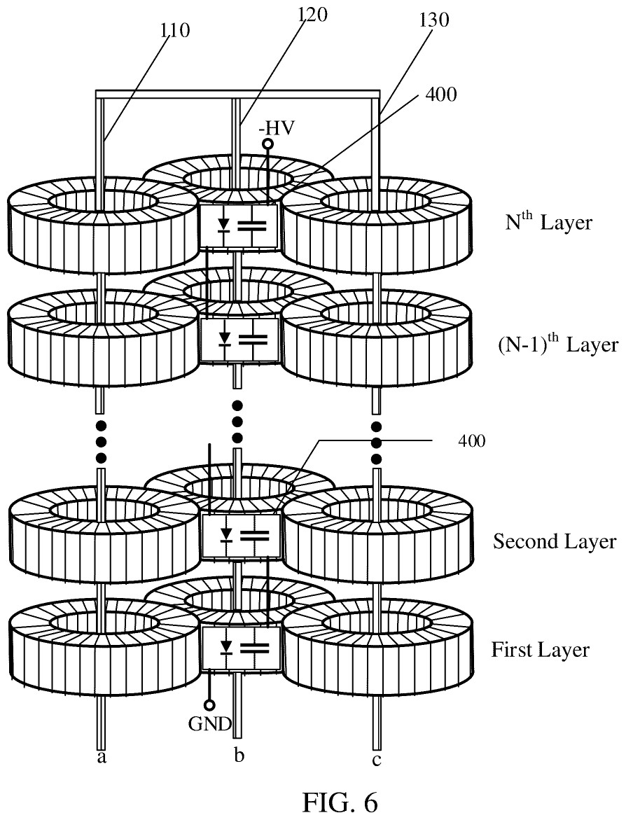

In this embodiment, as shown in FIG. 6, a first end of each primary winding 110, 120, 130 is supplied by an alternating current of a corresponding phase, and second ends of the primary windings 110, 120, 130 are connected to each other after passing through the centers of N distributed magnetic cores 200 sequentially. The N distributed magnetic cores 200 are located in N magnetic core groups, respectively, and the N magnetic core groups are arranged layer by layer. The number of the rectifier and filter circuits 400 is the same as the number of the magnetic core groups. After N rectifier and filter circuits 400 are connected in series, an end of the series circuit may be grounded, and another end thereof outputs a high voltage. For example, as shown in FIG. 6, the rectifier unit 410 corresponding to the first layer of magnetic core group is grounded, and the directions of forward currents of the diodes in the rectifier units 410 corresponding to respective layers of the magnetic core groups may determine whether the voltage outputted from the output end of the rectifier unit 410 corresponding to the N^{th} layer of magnetic core group is a positive high voltage or a negative high voltage.

In some embodiments, the M primary windings 100 are connected to each other after passing through 2N distributed magnetic cores 200 sequentially. In other words, each primary winding 100 passes through the 2N distributed magnetic cores 200 sequentially.

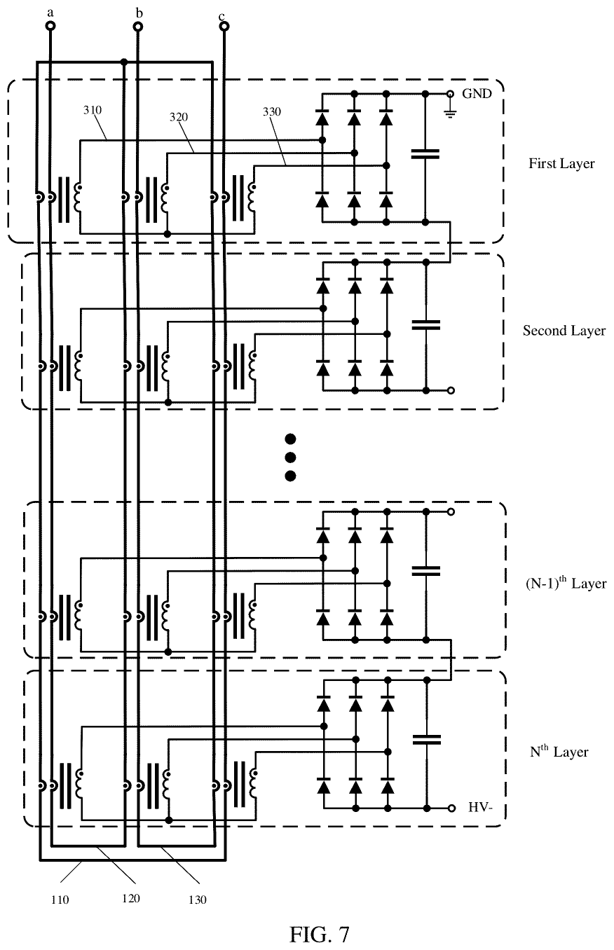

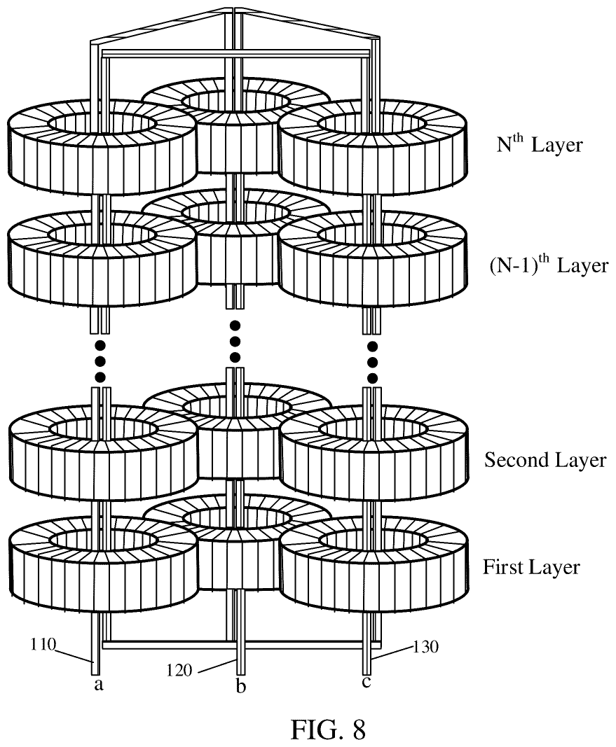

For example, an end of one of the primary windings 100 passes through N distributed magnetic cores 200 and then passes through the centers of another N distributed magnetic cores 200 to be connected to the other primary winding 100. In this case, the primary winding passes through two distributed magnetic cores 200 in the same magnetic core group, and the other primary winding 100 also passes through two distributed magnetic cores 200 in the same magnetic core group. As shown in FIG. 7, taking M equal to 3 as an example, the three primary windings of the distributed multiphase transformer may each pass through two distributed magnetic cores 200 in each layer of magnetic core group. FIG. 8 is a schematic perspective diagram of the distributed multiphase transformer in FIG. 7. In this case, the number of turns of the primary winding 100 may be multiple turns.

In an embodiment, the number of turns of the primary winding 100 may be K, indicating that the distributed magnetic core 200 is passed through by the primary winding 100 K times. K may be set according to the application environment or application requirement of the distributed multiphase transformer.

In an embodiment, as shown in FIGS. 7 and 8, each distributed magnetic core 200 is passed through by two primary windings 100.

As shown in FIG. 8, the first end a of the first primary winding 110 passes through the first distributed magnetic core 210 in the first layer of magnetic core group to the first distributed magnetic core 210 in the N^{th} layer of magnetic core group, and then passes through the second distributed magnetic core 220 in the N^{th} layer of magnetic core group to the second distributed magnetic core 220 in the first layer of magnetic core group. Similarly, the first end b of the second primary winding 120 passes through the second distributed magnetic core 220 in the first layer of magnetic core group to the second distributed magnetic core 220 in the N^{th} layer of magnetic core group, and then passes through the third distributed magnetic core 230 in the N^{th} layer of magnetic core group to the third distributed magnetic core 230 in the first layer of magnetic core group to be connected to the second end of the first primary winding 110. The first end c of the third primary winding 130 passes through the third distributed magnetic core 230 in the first layer of magnetic core group to the third distributed magnetic core 230 in the N^{th} layer of magnetic core group, and then passes through the first distributed magnetic core 210 in the N^{th} layer of magnetic core group to the first distributed magnetic core 210 in the first layer of magnetic core group to be connected to the second end of the first primary winding 110.

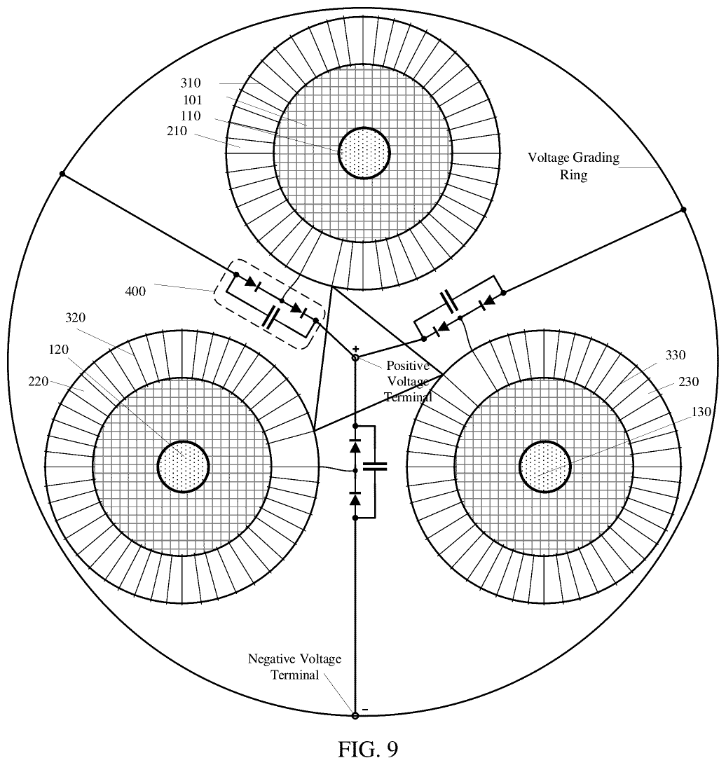

In some embodiments, as shown in FIG. 9, the rectifier and filter circuit 400 may be located between two adjacent distributed magnetic cores 200 in the same magnetic core group, and two output terminals of the rectifier and filter circuit 400 are inside and outside the magnetic core group, respectively. First ends of all the rectifier bridge arms in the rectifier and filter circuit 400 are connected to a common positive voltage terminal, and second ends of all the rectifier bridge arms outside may be connected to each other through a voltage grading ring. Such a design facilitates enhancing the reliability of high-voltage insulation.

In some embodiments, a compensation unit is connected between the secondary windings 300 on the M distributed magnetic cores 200 in each magnetic core group.

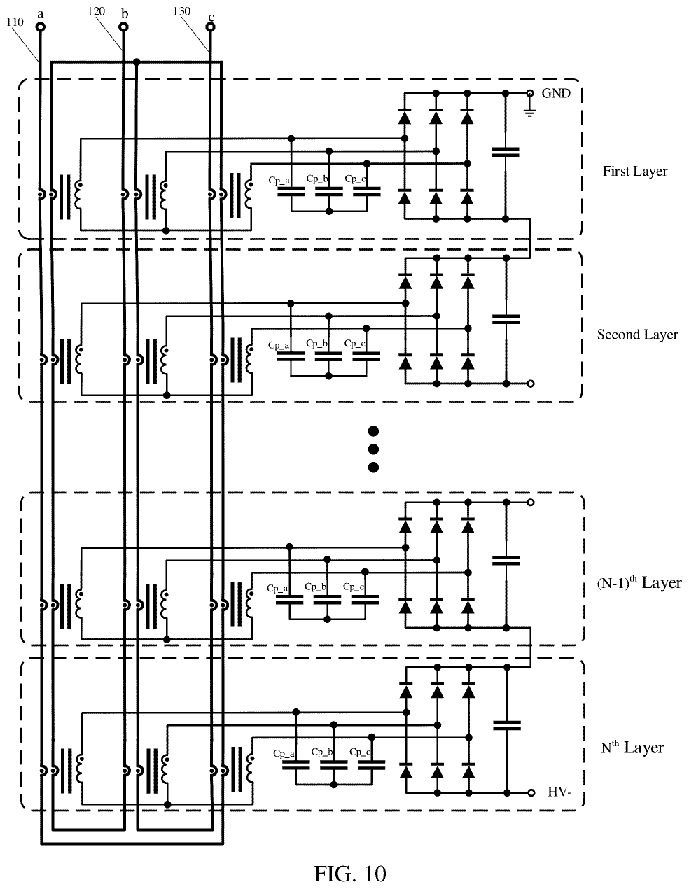

As shown in FIG. 10, a parallel capacitor may be provided between the secondary windings 300 in each layer of magnetic core group as the compensation unit. The parallel capacitor may suppress the voltage imbalance caused by a difference in the distributed magnetic cores 200 or the secondary windings 300. In a case that the output capacitance is relatively small, the parallel capacitor may suppress the difference in the distributed magnetic cores 200, thus reducing the problem of the voltage imbalance caused by the imbalance of the distributed magnetic cores 200, thereby reducing the loss of the front end.

Specifically, with reference to FIG. 10, the compensation unit may include a first compensation capacitor Cp_a, a second compensation capacitor Cp_b, and a third compensation capacitor Cp_c. The first compensation capacitor Cp_a is provided between the first secondary winding 310 and the corresponding rectifier unit 410, the second compensation capacitor Cp_b is provided between the second secondary winding 320 and the corresponding rectifier unit 410, and the third compensation capacitor Cp_c is provided between the third secondary winding 330 and the corresponding rectifier unit 410. Ends of the first compensation capacitor Cp_a, the second compensation capacitor Cp_b, and the third compensation capacitor Cp_c are connected to the first secondary winding 310, the second secondary winding 320, and the third secondary winding 330, respectively, and the other ends of the first compensation capacitor Cp_a, the second compensation capacitor Cp_b, and the third compensation capacitor Cp_c are connected to each other.

In some embodiments, FIG. 11 is a schematic diagram showing a circuit structure of a distributed three-phase transformer. As shown in FIG. 11, the ends of the secondary windings 300 in each layer of the magnetic core group are connected to the corresponding rectifier bridge arm in the rectifier unit 410, respectively, and the other ends thereof are connected to each other according to the delta connection method.

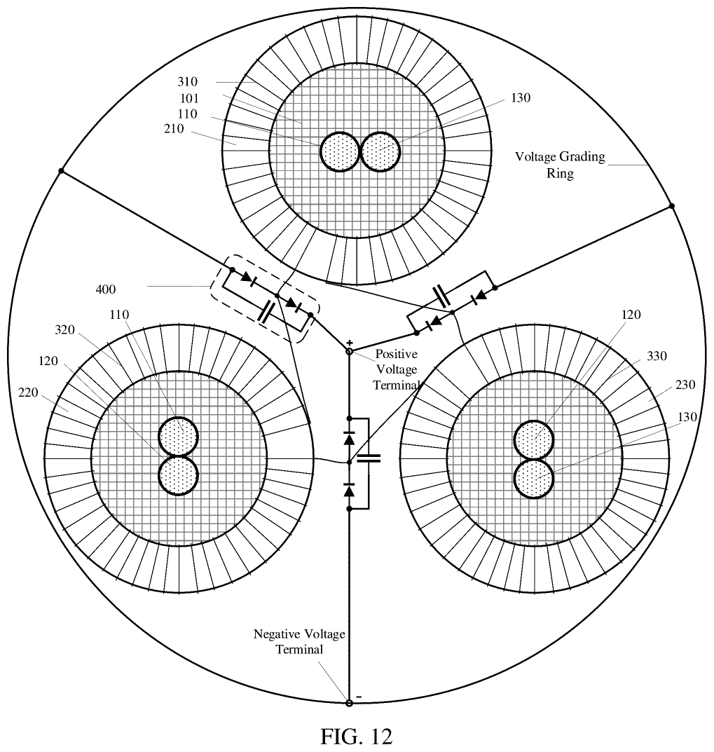

FIG. 12 is a schematic diagram showing a partial structure of a distributed three-phase transformer according to some embodiments in a case M is equal to 3. As shown in FIG. 12, in each layer of magnetic core group, three distributed magnetic cores 200 are arranged in a triangle shape, and each distributed magnetic core 200 is provided with the corresponding secondary winding 300. An end of each secondary winding 300 is connected to the corresponding rectifier bridge arm in the rectifier unit 410, and another end of each secondary winding 300 is connected to an end of the adjacent secondary winding 300.

In some embodiments, as shown in FIGS. 7, 8, 10, 11 and 12, each distributed magnetic core 200 is passed through by two different primary windings.

In some embodiments, the distributed multiphase transformer further includes N printed circuit boards configured to fix the N magnetic core groups, respectively. Each printed circuit board is provided with M through holes. The M through holes are configured to receive the M distributed magnetic cores 200 in each magnetic core group.

In this embodiment, the M through holes on the printed circuit board are arranged in a one-to-one correspondence with the M distributed magnetic cores 200 in the magnetic core group, respectively. Each primary winding 100 passes through the N distributed magnetic cores 200 sequentially.

In some embodiments, as shown in FIG. 12, a first end of each secondary winding 300 on the M distributed magnetic cores 200 in each magnetic core group is connected to the positive voltage terminal via the corresponding rectifier bridge arm in the rectifier unit 410, and a second end of each secondary winding 300 on the M distributed magnetic cores 200 in each magnetic core group is connected to an end of the adjacent secondary winding 300 (i.e., the delta connection method).

In some embodiments, as shown in FIG. 9, a first end of each secondary winding 300 on the M distributed magnetic cores 200 in each magnetic core group is connected to the positive voltage terminal via the corresponding rectifier bridge arm in the rectifier unit 410, and second ends of the secondary windings 300 on the M distributed magnetic cores 200 in each magnetic core group are connected to a common connection point (i.e., the star connection method).

In an embodiment, as shown in FIGS. 9 and 12, the ends of all rectifier bridge arms are connected to the common positive voltage terminal, and the other ends of all rectifier bridge arms are connected to the negative voltage terminals, respectively, and the negative voltage terminals of adjacent rectifier bridge arms may be connected to each other through a voltage grading ring.

In this embodiment, the rectifier bridge arm is formed by two diodes connected in series, and the positive voltage terminal and the negative voltage terminal of the rectifier bridge arm are determined by the direction of forward current of the diodes in the rectifier bridge arm.

In some embodiments, the N printed circuit boards are arranged layer by layer, and the directions of forward currents of the rectifier bridge arms between two adjacent printed circuit boards are opposite. The direction of the forward current of the rectifier bridge arm is determined by the direction of the forward current of the diode of the rectifier bridge arm.

In this embodiment, as shown in FIG. 12, the common connection point of the cathodes of the diodes in the rectifier bridge arms is taken as the positive voltage terminal of the rectifier bridge arm. In this case, the positive voltage terminal is located at the center point of the three distributed magnetic cores 200. By setting the directions of forward current of the diodes of the rectifier bridge arms of the adjacent printed circuit board to be opposite, the negative voltage terminal of the rectifier bridge arms on the adjacent printed circuit board is located at the center point of the three distributed magnetic cores 200. Such a design can facilitate serial connection of rectifier and filter circuits 400 at different layers, and has the advantages of simple structure and no need for complicated wiring.

An embodiment of the present disclosure further provides an X-ray system, including the distributed multiphase transformer as described in any one of the above embodiments.

Compared with the related art, the disclosed embodiments have the following beneficial effects. The distributed multiphase transformer includes M primary windings and M*N distributed magnetic cores. The M primary windings are supplied by a M-phase alternating current, a first end of each of the M primary windings is supplied by an alternating current of a corresponding phase in the M-phase alternating current, and second ends of the M primary windings are connected to each other after passing through a plurality of distributed magnetic cores in the M*N distributed magnetic cores. The secondary winding on each distributed magnetic core is connected to the corresponding rectifier unit, and a plurality of rectifier units are connected in series to output a secondary voltage. Such a design can reduce the output capacitance of the distributed multiphase transformer and achieve faster peak high voltage switching without increasing the ripple in the output voltage.

The embodiments described above are only used to illustrate the technical solutions of the present disclosure, rather than to limit them. Although the present disclosure has been described in detail with reference to the aforementioned embodiments, those skilled in the art should understand that they can still modify the technical solutions described in the aforementioned embodiments, or make equivalent replacements for some of the technical features therein. Such modifications or replacements do not deviate the essence of the corresponding technical solutions from the spirit and scope of the technical solutions of the embodiments of the present disclosure, and should all be included in the protection scope of the present disclosure.

What is claimed is:

1. A transformer, comprising:
M primary windings, M being an integer greater than or equal to 3, and the M primary windings being supplied with a M-phase alternating current; and
M*N distributed magnetic cores, N being an integer greater than or equal to 2;
wherein a first end of each of the M primary windings is supplied with an alternating current of a corresponding phase in the M-phase alternating current, and second ends of the M primary windings are connected to each other after passing through a plurality of distributed magnetic cores in the M*N distributed magnetic cores; and
wherein each of the M*N distributed magnetic cores is provided with a corresponding secondary winding, and each secondary winding is connected to a corresponding one of a plurality of rectifier units connected in series.

2. The transformer of claim 1, wherein the M*N distributed magnetic cores are divided into N magnetic core groups, and each magnetic core group comprises M distributed magnetic cores.

3. The transformer of claim 2, wherein ends of the secondary windings on the M distributed magnetic cores in each magnetic core group are connected to each other according to a delta connection method or a star connection method.

4. The transformer of claim 2, wherein dotted terminals of the secondary windings on the M distributed magnetic cores in each magnetic core group are connected to each other.

5. The transformer of claim 2, wherein the secondary windings on the M distributed magnetic cores in each magnetic core group have a same number of turns.

6. The transformer of claim 1, wherein the M primary windings are connected to each other after passing through N distributed magnetic cores sequentially.

7. The transformer of claim 6, wherein projections of the N distributed magnetic cores through which each primary winding passes coincide with each other on a horizontal plane.

8. The transformer of claim 1, wherein the M primary windings are connected to each other after passing through 2N distributed magnetic cores sequentially.

9. The transformer of claim 8, wherein each distributed magnetic core is passed through by two primary windings.

10. The transformer of claim 2, wherein a number of the rectifier units is the same as a number of the magnetic core groups, and the N magnetic core groups are connected to N rectifier units in a one-to-one correspondence.

11. The transformer of claim 1, wherein an output end of each rectifier unit is connected in parallel with at least one filtering unit.

12. The transformer of claim 2, wherein a compensation unit is connected between secondary windings on the M distributed magnetic cores in each magnetic core group.

13. The transformer of claim 12, wherein each compensation unit comprises M compensation capacitors connected in parallel.

14. The transformer of claim 2, further comprising:
N printed circuit boards configured to fix the N magnetic core groups, respectively, each printed circuit board being provided with M through holes, and the M through holes being configured to receive the M distributed magnetic cores in each magnetic core group.

15. The transformer of claim 14, wherein the M distributed magnetic cores in each magnetic core group are arranged in a one-to-one correspondence with the M through holes, and the M distributed magnetic cores are arranged in a triangle shape in a case that M is equal to 3.

16. The transformer of claim 14, wherein an end of each secondary winding on the M distributed magnetic cores in each magnetic core group is connected to a corresponding rectifier bridge arm in the rectifier unit, and another end of each secondary winding on the M distributed magnetic cores in each magnetic core group is connected to an adjacent secondary winding.

17. The transformer of claim 16, wherein each rectifier bridge arm comprises at least two diodes, and the at least two diodes are connected in series.

18. The transformer of claim 16, wherein first ends of all the rectifier bridge arms in each rectifier unit are connected to a common connection point, and second ends of all the rectifier bridge arms in each rectifier unit are connected to each other through a voltage grading ring.

19. The transformer of claim 16, wherein the N printed circuit boards are arranged layer by layer, and directions of forward currents of the rectifier bridge arms between two adjacent printed circuit boards are opposite.

20. An X-ray system, comprising a transformer, wherein the transformer comprises:
M primary windings, M being an integer greater than or equal to 3, and the M primary windings being supplied with a M-phase alternating current; and
M*N distributed magnetic cores, N being an integer greater than or equal to 2;
wherein a first end of each of the M primary windings is supplied with an alternating current of a corresponding phase in the M-phase alternating current, and second ends of the M primary windings are connected to each other after passing through a plurality of distributed magnetic cores in the M*N distributed magnetic cores; and
wherein each of the M*N distributed magnetic cores is provided with a corresponding secondary winding, and each secondary winding is connected to a corresponding one of a plurality of rectifier units connected in series.
